(19) United States
(12) Patent Application Publication
(10) Pub. No.: US 2003/0102714 A1
(43) Pub. Date: Jun. 5, 2003

(54) Speed controller

(76) Inventors: Christopher Rhodes, Victoria (AU); Richard Andrew Myrtle, Victoria (AU)

Correspondence Address: BANNER & WITCOFF, 1001 G STREET N W, SUITE 1100, WASHINGTON, DC, 20001, US

(21) Appl. No.: 10/149,020

(22) PCT Filed: Dec. 6, 2000
(86) PCT No.: PCT/AU00/01502

(30) Foreign Application Priority Data
Dec. 6, 1999 (AU) PQ-4484

(51) Int. Cl. B60T 8/32

(52) U.S. Cl. 303/193; 303/191

(57) ABSTRACT

A system for selectively limiting the speed of a vehicle, wherein said system includes a sensor device (14) located on the vehicle, the sensor (14) being directed away from the vehicle so as to detect a structure nearby the vehicle, and a controller (12) which, in response to the sensor (14) detecting the structure imposes a predetermined speed limit on the vehicle.

### FIELD OF THE INVENTION

This invention relates to speed control of vehicles and has particular application to the speed control of vehicles, such as forklifts, that are often used in indoor areas having speed restrictions.

### BACKGROUND OF THE INVENTION

In most workplaces today there is considerable emphasis on safety in the workplace. One area for improvement is the operation of machinery and vehicles in indoor speed restricted areas.

Speed controlling devices for vehicles, particularly cars and trucks, are well known. Many of these known speed controlling devices act to permanently limit the maximum speed of the vehicle usually in response to a preset speed limit or in response to external stimuli such as road markings.

Vehicles such as forklifts are typically operated in workplaces where there are safety zones e.g. inside a factory where pedestrians share the pathways. These safety zones are typically restricted vehicle speed areas so as to reduce the risk of accidents and injury.

One system of controlling the speed of a forklift includes a built-in speed limiter which controls the maximum speed of the forklift to a single predetermined fixed value. A system of this type limits the speed of the forklift wherever the forklift may be, even when the forklift is outside in the open where speed restrictions may not exist. A further disadvantage of this existing system is that it is not suitable for use on electric vehicles. The speed limiter is typically mounted in the differential and measures the speed of the vehicle. The measured speed is converted by an electronic control unit into a control signal which controls a stepping motor.

Other known types of speed controllers automatically set the speed of the vehicle depending on the location of the vehicle. These types of speed controllers suffer the disadvantage that they do not allow any manual control of the speed of the vehicle.

There is therefore a need to regulate the speed of vehicles or machinery to suit the prevailing speed restrictions.

It is therefore an object of the invention to provide a speed controller for vehicles which selectively limits the speed of the vehicle.

### SUMMARY OF THE INVENTION

The invention accordingly provides a system for selectively limiting the speed of a vehicle, wherein said system includes a sensor device located on the vehicle, the sensor being directed away from the vehicle so as to detect a structure nearby the vehicle, and a controller which, in response to the sensor detecting the structure, imposes a speed limit on the vehicle.

Advantageously, the sensor is located on an upper surface of the vehicle, the sensor being directed upwardly so as to detect a structure above the vehicle.

The system may also incorporate a colour sensor mounted on the vehicle to detect different speed zones indicated by different colour markings or other electronic sensing on the floor or walls of a factory, for example.

Advantageously, the vehicle is a forklift, or other load-moving vehicle commonly used indoors.

Preferably, the controller adjusts the vehicles speed with the use of an electronic device which is powered by the vehicle's power supply. The electronic device adjusts an actuator which is connected to the vehicle's throttle. The controller responds to the vehicle's speed via a speed detector and, via the electronic device, corrects the accelerator to enforce a maximum speed depending on the location of the vehicle.

Preferably, the structure is the roof of a building. Speed restricted areas are typically located inside factories where the confined floor space is shared with pedestrians. Alternatively, the structure may be one or more bridge-like structures passing over a road or pathway. The structure may also take the form of a transmitting device, which sends a signal to the sensor on the vehicle identifying the vehicle's location and the relevant speed limit.

The vehicle preferably has at least one predetermined speed, and more preferably has two maximum speeds—one for inside a building, for example, and one for outside a building. Alternatively, the vehicle may have multiple speeds available.

### BRIEF DESCRIPTION OF DRAWINGS

The invention will now be described by way of example with reference to the accompanying drawings in which:

FIG. 1 is a schematic side view of a forklift truck equipped with a speed controller in accordance with the present invention; and

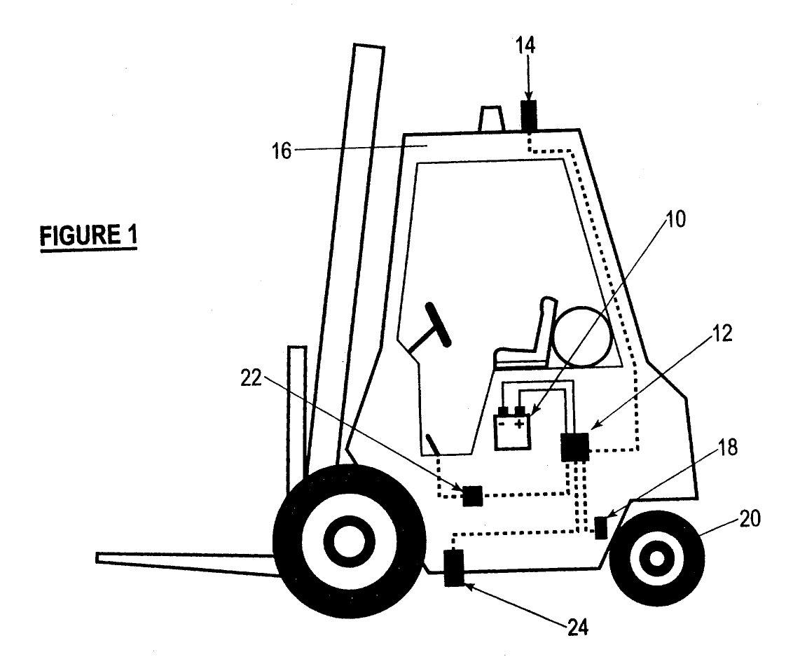

FIG. 2 is a flow chart illustrating a preferred control sequence.

### DESCRIPTION OF PREFERRED EMBODIMENTS

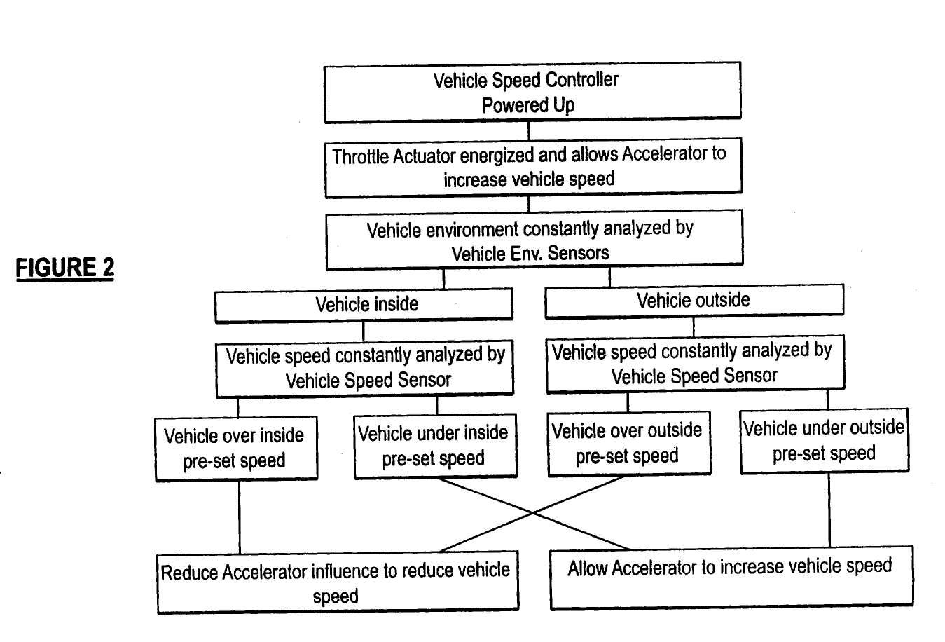

To refer to the drawings, there is shown a forklift truck of known design and construction. The forklift truck has a battery 10 which forms the power supply for the present invention. The battery 10 powers a central control unit 12 and accelerator control unit 22. Control unit 12 signals accelerator control unit 22 when it is necessary to adjust the speed of the vehicle, as described below. The sequence of operation of the control unit 12 is illustrated in FIG. 2.

An indoor/outdoor sensor 14 is mounted on the roof 16 of the truck. The sensor 14 is directed upwardly so that, when the truck is inside, the sensor 14 is able to receive a reflected signal from the roof or ceiling of the building (not shown) and will provide a signal to the control unit 12. The sensor 14 may be of any suitable type such as, for example, microwave, infrared, laser, or radar.

When the truck is outdoors there may be provided one or more bridge-like structures passing over a road or pathway, which the sensor 14 can detect as the truck passes underneath. Alternatively, the sensor 14 may detect a transmitting device (not shown), which sends a signal to the sensor 14 identifying the vehicle's location, whether indoors or outdoors, and the relevant speed limit.

The speed of the truck is preferably measured by means of a speed sensor 18 which can determine the speed of the truck by, for example, measuring the rotational speed of the adjacent wheel 20. Alternatively, the speed of the truck may be determined using a sensor which detects the ground speed of the vehicle. The speed sensor may be of any suitable type such as, for example, microwave, infrared, laser, or radar. The speed of the truck is passed to the control unit 12.

If the speed of the truck is above the preset inside maximum speed, and if the sensor 14 receives a return signal, the control unit 12 will signal the accelerator control unit 22 to reduce the speed of the truck until sensor 14 determines that it is at or below the preset speed. The accelerator control unit 22 adjusts an actuator (not shown) which is connected to the vehicle's throttle (not shown), so as to correct the accelerator and impose a maximum speed on the vehicle.

Naturally, if the speed of the truck is at the preset limit, the control unit 12 does nothing.

If the speed is below the preset limit, the control unit 12 will allow the truck driver to increase the truck speed, but will not automatically increase the truck speed as the truck driver may have a valid reason for driving at less than the preset speed limit.

The accelerator control unit 22 serves to control the rate of acceleration of the truck depending on how close the truck speed is to the relevant speed limit. For example, if the truck is travelling at a speed just below the allowed speed limit, the accelerator control until 22 will permit the truck to accelerate slowly up to the speed limit so that the speed limit is not passed.

When the sensor 14 does not receive a return signal, thus signifying there is no roof and the truck is outdoors, the control unit 12 will allow the speed of the truck to be increased (if the driver so desires) to either an upper limited speed, or an unlimited (within the confines of the truck's capabilities) speed.

A further sensor 24, being a ground surface sensor, may be provided in addition to sensor 14, or in place of sensor 14. The sensor 22 can detect certain floor characteristics to thus determine if the truck is in a region requiring the lower, or higher, speed limit. The characteristics may include painted surfaces, bar codes, reflectors, or any other suitable, indicia.

Alternatively, either or both sensors 14, 24 may be able to detect the change from one zone to another, for example, from a higher speed limit zone to a lower speed limit zone—and to maintain the present maximum speed limit for that zone while still remaining in that zone. This may be achieved by use of appropriate signal generators at zone boundaries, or use of indicia devices such as, for example, painted surfaces, bar codes, or the like.

The painted floor characteristics described above may involve the use of different colours and/or patterns in the paint, if desired. Where different coloured painted surfaces are used, the sensors 14, 24 are preferably colour sensors mounted on the vehicle to detect different speed zones indicated by different colour markings.

There may also be more than two predetermined speed limits so that there may be a lowest speed limit, a highest speed limit, and a required number of intermediate speed limits therebetween.

It will be appreciated that the present invention provides a speed controller for a vehicle, particularly vehicles such as forklifts commonly used indoors, that enables the speed of the vehicle to be selectively limited depending on the location of the vehicle. Using the speed controller of the present invention enables the vehicle to travel at multiple speeds, and retains manual control of the speed of the vehicle provided that speed is below a predetermined speed limit imposed by the speed controller. It will also be appreciated that the present invention can be used to control the speed of other load-moving vehicles commonly used indoors.

It will be understood that the invention disclosed and defined in this specification extends to all alternative combinations of two or more of the individual features mentioned or evident from the text or drawings. All of these different combinations constitute various alternative aspects of the invention.

The claims defining the invention are as follows:

1 [Amended] A system for selectively limiting the speed of a vehicle, wherein said system includes a sensor device located on the vehicle, the sensor being directed away from the vehicle so as to detect a structure nearby the vehicle, and a controller which, in response to the sensor detecting a structure, imposes a predetermined speed limit on the vehicle, such that the vehicle can be operated at or below the predetermined speed limit.

2 A system according to claim 1, wherein the vehicle has at least one predetermined speed limit.

3 A system according to claim 1 or 2, wherein the vehicle has two or more predetermined speed limits.

4 A system according to any preceding claim, further including a speed detector mounted on the vehicle for determining the speed of the vehicle.

5 A system according to claim 4, wherein if the vehicle speed is above a predetermined speed at the time of detection of a structure, the controller reduces the speed of the vehicle until the speed is at or below the predetermined speed.

6 A system according to any preceding claim, wherein the sensor is located on an upper surface of the vehicle, the sensor being directed upwardly so as to detect a structure above the vehicle.

7 A system according to claim 6, wherein the structure is the roof of a building.

8 A system according to claim 6, wherein the structure is one or more bridge-like structures passing over a road or pathway.

9 A system according to any preceding claim, wherein the system further includes a colour sensor mounted on the vehicle to detect different speed zones indicated by different colour markings.

10 A system according to any preceding claim, wherein the controller adjusts the vehicle's speed with the use of an electronic device which is powered by the vehicle's power supply.

11 A system according to claim 10, wherein the electronic device adjusts an actuator which is connected to the vehicle's throttle.

12 A system according to claim 11, wherein the controller responds to the vehicle's speed and, via the electronic device, corrects the accelerator to enforce a maximum speed depending on the location of the vehicle.

13 A system according to any preceding claim, wherein the vehicle is a load-moving vehicle commonly used indoors.

14 A system according to any preceding claim, wherein the vehicle is a forklift.
